(19) United States
(12) Patent Application Publication
(10) Pub. No.: US 2013/0258696 A1
(43) Pub. Date: Oct. 3, 2013

(54) Light diffuser for a headlamp

(71) Applicant: GM GLOBAL TECHNOLOGY OPERATIONS LLC, Detroit, MI (US)

(72) Inventors: Thomas FEID, Mannheim (DE); Ingolf SCHNEIDER, Ruesselsheim (DE); Justus ILLIUM, Mainz (DE); Andreas BARTH, Wiesbaden (DE); Frank LANGKABEL, Ruesselsheim (DE); Philipp ROECKL, Aschaffenburg (DE); Martin KOPPELT, Rockenhausen (DE); Torsten KANNING, Eltville-Erbach (DE)

(73) Assignee: GM GLOBAL TECHNOLOGY OPERATIONS LLC, Detroit, MI (US)

(21) Appl. No.: 13/780,768

(22) Filed: Feb. 28, 2013

(30) Foreign Application Priority Data
Mar. 29, 2012 (DE) 10 2012 006 505.1

(51) Int. Cl. F21S 8/10

(52) U.S. Cl. CPC F21S 48/1225
USPC 362/516

(57) ABSTRACT

A light diffuser for a vehicle headlamp having a plurality of light sources that each is arranged inside a reflector is provided. The light diffuser is capable of representing a light-dark boundary of the low beams generated by the light sources without interruption, and is capable of diffusely scattering the daytime running lights emitted by the light sources so as to generate a homogenous exit of light for the light sources.

### CROSS-REFERENCE TO RELATED APPLICATION

This application claims priority to German Patent Application No. 10 2012 006 505.1, filed Mar. 29, 2012, which is incorporated herein by reference in its entirety.

### TECHNICAL FIELD

The technical field generally relates to a light diffuser for a headlamp, and in particular for a multifunction headlamp with daytime running lights.

### BACKGROUND

Vehicle headlamps known from general prior art are usually divided into projection headlamps and reflection headlamps in terms of their design. Known projection headlamps exhibit a shade that suitably limits the light emission during operation in the low beam mode, but is lifted in the high beam mode. In addition, lawmakers have prescribed that motor vehicles have additional headlamp components, such as a daytime running light.

More recent vehicle headlamp developments are changing over to provide multifunctional reflector or projector systems as matrix headlamps. Several light functions, e.g., low beam and daytime running lights, are here generated using the same reflector geometry.

One problem here is that individual reflectors appear dark when viewed at different angles in daytime running light operation, yielding a less than attractive appearance.

A vehicle headlamp is depicted in DE 102007005779 A1. The headlamp described in this publication provides an optical fiber that takes the light not emitted in the traveling direction, which normally is lost, and reflects it forward via a reflection system. In addition to slightly increasing the homogeneity, this is intended above all to improve the efficiency of a fiber optics system.

At least one object herein is to provide a light diffuser that improves light emission. In addition, other objects, desirable features and characteristics will become apparent from the subsequent summary and detailed description, and the appended claims, taken in conjunction with the accompanying drawings and this background.

### SUMMARY

In accordance with an exemplary embodiment, a vehicle headlamp is a light diffuser, which is arranged on several reflectors that each exhibit a light source. A light/dark boundary of a low beam generated by the light sources can be represented without interruption. A daytime running light emitted by the light sources is diffusely scattered through the light diffuser, so as to generate a homogenous exit of light for the light sources.

In addition to optimizing light distribution, the light diffuser according to an embodiment also optimizes the visual appearance, so that the individual reflectors can be perceived as an overall picture. This yields an elevated homogeneity of the daytime running lights and low beams for the outside observer, as well as an improved distribution of light in the low beams.

In another embodiment, the light diffuser exhibits a profile running perpendicular to the light/dark boundary.

As a result, it is possible to still sharply delineate the light/dark boundary, since the light/dark boundary is hence not influenced by the light scattering in the light diffuser.

In another embodiment, the profile is designed as a corrugation with a plurality of structural elements.

This enables a simple and cost-effective realization of the light diffuser. The corrugation must here run vertically to continue sharply delineating the light/dark boundary.

In another embodiment, the plurality of structural elements is arranged vertically to a roadway.

Since the light/dark boundary is usually designed in a horizontal direction, the structural elements can be aligned in a direction perpendicular thereto.

In another embodiment, the light diffuser is made out of a transparent plastic material.

This enables a simple and cost-effective structural design for the light diffuser given a simultaneously high transparency.

In another embodiment, the light diffuser is secured to the reflectors or to the light sources.

In a further embodiment, the geometric alignment of the light diffuser runs in a vertical direction, and is rigidly mounted on the reflectors or light source. The attachment is not mechanically separated from the reflectors or light source, e.g., as is the case for LED daytime running lights from prior art.

Also provided in accordance with an embodiment is a vehicle headlamp that encompasses light sources arranged in the form of a matrix, which are suitable for emitting a daytime running light or low beam via respective reflectors, and exhibits a light diffuser described above.

The light sources can be designed as OLED's, a TFT field, an LED field or an array of individual LED's.

As a result, a plurality of light sources can be easily incorporated in a vehicle headlamp.

The light diffuser can be secured to the reflectors or to the light sources.

Also provided in accordance with an embodiment is the use of a light diffuser described above in a multifunctional reflector or projector system, for example in a matrix headlamp.

### BRIEF DESCRIPTION OF THE DRAWINGS

The various embodiments will hereinafter be described in conjunction with the following drawing figures, wherein like numerals denote like elements, and wherein:

FIG. 1 is a cross sectional view of a vehicle headlamp in accordance with an embodiment of the invention;

FIG. 2 is a front view of a vehicle headlamp according to an embodiment and

FIG. 3 is a front view of a vehicle headlamp according to comparative example.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

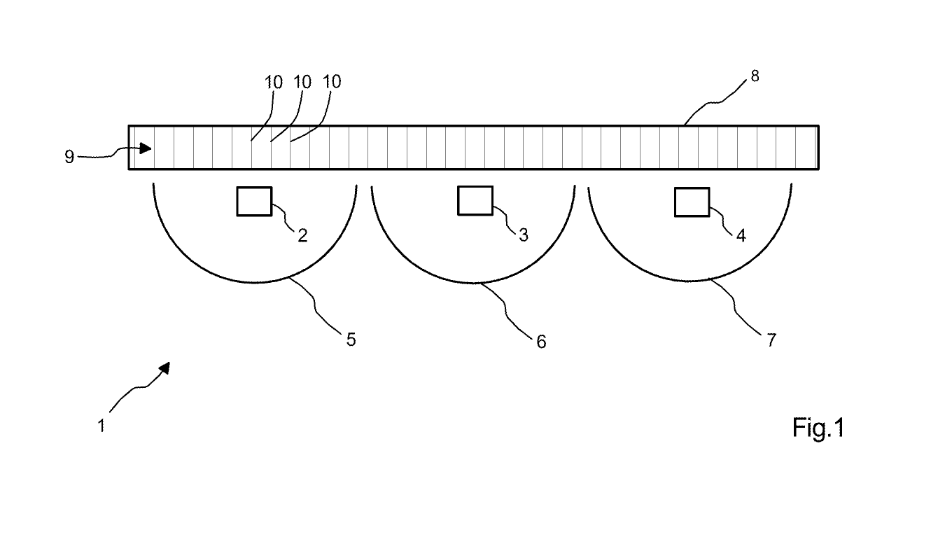

FIG. 1 shows a cross sectional view of a vehicle headlamp 1 in a first embodiment. The section here follows a horizontal plane, i.e., lies in a plane parallel to a roadway. The vehicle headlamp 1 encompasses a plurality of individual light sources provided with reference numbers 2, 3 and 4 on FIG. 1. The first light source 2 is arranged inside a first reflector 5, so that the emitted light can exit the vehicle headlamp 1. Accordingly, the second light source 3 and third light source 4 are situated in a second reflector 6 and in a third reflector 7, respectively. At least two differently emitting and arranged light sources are basically provided.

As a result, several light functions, such as daytime running lights and low beams, are generated from the same reflector geometry for reflectors 5, 6 and 7. The vehicle headlamp 1 is a so-called matrix headlamp, which is also known as a multifunctional reflector or projector system.

Light sources 2, 3 and 4 can be designed as OLED's, a TFT field, an LED field or an array of individual LED's. Use can also be made of other, more conventional solutions, e.g., halogen lamps or the like.

Arranged in the direction of the emitted light is a light diffuser 8, which can represent a light/dark boundary of a low beam generated by the light sources 2, 3, 4 without interruption, and diffusely scatters a daytime running light emitted by the light sources 2, 3, 4 through the light diffuser 8, so as to generate a homogeneous exit of light for the light sources 2, 3, 4.

To this end, the light diffuser 8 exhibits a profile denoted on FIG. 1 by reference number 9. The profile here runs perpendicular to the light/dark boundary, meaning vertically to a roadway. The profile 9 is designed as a corrugation with a plurality of structural elements 10.

In an embodiment, the light diffuser 8 is made out of a transparent plastic material. The light diffuser 8 is secured to the reflectors 5, 6, 7 or to the light sources 2, 3, 4.

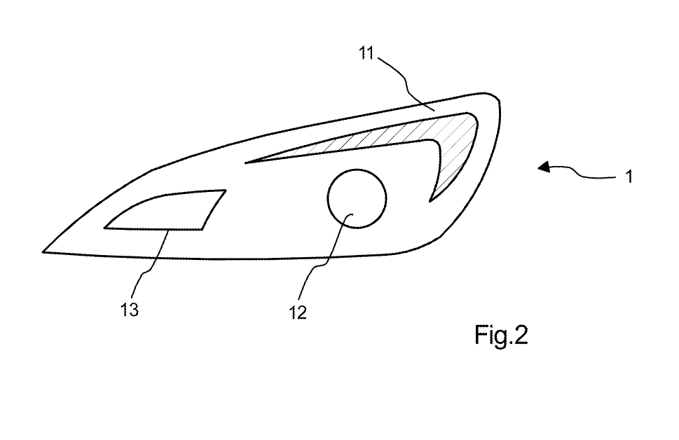

The resultant distribution of light for the vehicle headlamp 1 is shown on FIG. 2. The vehicle headlamp 1 exhibits a first area 11, which is provided for emitting the daytime running lights. In addition, the vehicle headlamp 1 exhibits a second area 12 provided for emitting the low beam lights. Additional light functions, e.g., fog lamps or turn signals, can also be realized, and are denoted on FIG. 2 by the third area 13.

In addition to optimizing the distribution of light, the light diffuser 8 also optimizes the visual appearance, so that the individual reflectors 5, 6, 7 can be perceived as an overall picture, as a result of which the first area 11 of the daytime running lights is depicted as a homogeneous surface. Similarly, the second area 12 is illuminated in a correspondingly homogeneous manner, but without in the process influencing the light/dark boundary, since the latter runs perpendicular to the corrugation 9. This yields an elevated homogeneity of the daytime running lights and low beams for the outside observer, as well as an improved distribution of light in the low beams.

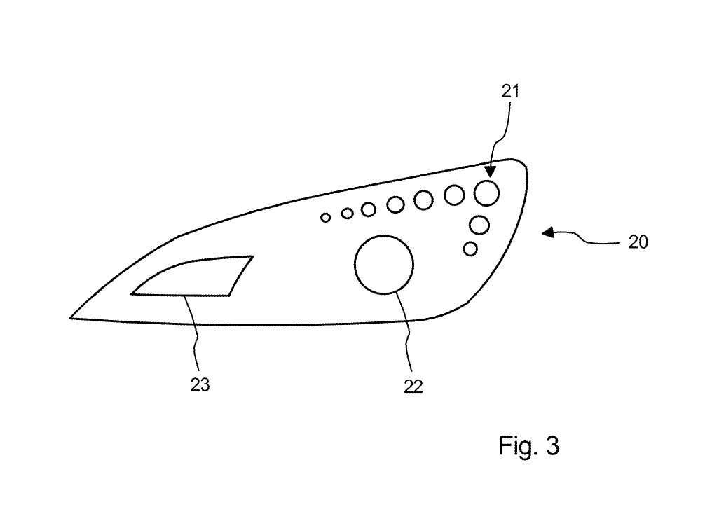

By comparison, FIG. 3 presents a comparative example of a vehicle headlamp 20 designed without the light diffuser 8. In addition to a first area 21 of the daytime running lights, the vehicle headlamp 20 exhibits a second area 22 for emitting the low beams and a third area 23, which can have the same function as in the exemplary embodiment described above. As clearly evident, the individual reflectors first appear dark when viewed from different angles in daytime running light operation, thereby yielding a less than attractive appearance.

Even though several possible embodiments were disclosed in the preceding specification, it goes without saying that numerous other variants exist for the embodiments as potential combinations of all technical features and embodiments, both those cited and those obvious to the expert. It is further understood that the exemplary embodiments are only to be understood as examples, which in no way limit the protective scope, applicability and configuration. Rather, the above specification is intended to illustrate a suitable way for the expert to realize at least one exemplary embodiment. Of course, numerous modifications can be made to an exemplary embodiment in terms of the function and arrangement of elements, without departing from the protective scope disclosed in the claims or its equivalents.

1. A light diffuser for a vehicle headlamp having a plurality of light sources is arranged inside a reflector, wherein:
the light diffuser is capable of representing a light-dark boundary of low beams generated by the light sources without interruption, and
the light diffuser is capable of diffusely scattering daytime running lights emitted by the light sources, so as to generate a homogenous exit of light for the light sources.

2. The light diffuser according to claim 1, in which the light diffuser exhibits a profile running perpendicular to the light/dark boundary.

3. The light diffuser according to claim 2, wherein the profile is corrugation with a plurality of structural elements.

4. The light diffuser according to claim 3, wherein the plurality of structural elements is situated vertically to a roadway.

5. The light diffuser according to claim 1, wherein the light diffuser is made out of a transparent plastic material.

6. The light diffuser according to claim 1, wherein the light diffuser is secured to the plurality of light sources or the reflectors.

7. A vehicle headlamp that comprises light sources arranged in a form of a matrix, wherein the light sources are suitable for emitting a daytime running light or a low beam via respective reflectors, and that comprises a light diffuser, wherein:
the light diffuser is capable of representing a light-dark boundary of the low beams generated by the light sources without interruption, and
the light diffuser is capable of diffusely scattering the daytime running lights emitted by the light sources, so as to generate a homogenous exit of light for the light sources.

8. A vehicle headlamp according to claim 7, wherein the light sources are OLED's, a TFT field, an LED field or an array of individual LED's.

9. A vehicle headlamp according to claim 7, wherein the light diffuser is secured to the respective reflectors or to the light sources.

10. A method for distributing light for a vehicle headlamp that comprises light sources, wherein the light sources are suitable for emitting a daytime running light or a low beam via respective reflectors, and that comprises a light diffuser, wherein:
the light diffuser is capable of representing a light-dark boundary of the low beams generated by the light sources without interruption, and
the light diffuser is capable of diffusely scattering the daytime running lights emitted by the light sources, so as to generate a homogenous exit of light for the light sources, the method comprising:
emitting the daytime running lights in a first area of the vehicle headlamp, and
emitting the low beam lights in a second area of the vehicle headlamp.

11. The vehicle headlamp according to claim 7, wherein the light diffuser exhibits a profile running perpendicular to the light/dark boundary.

12. The vehicle headlamp according to claim 11, wherein the profile is a corrugation with a plurality of structural elements.

13. The vehicle headlamp according to claim 12, wherein the plurality of structural elements is situated vertically to a roadway.

14. The vehicle headlamp according to claim 7, wherein the light diffuser is made out of a transparent plastic material.
